(19) United States
(12) Patent Application Publication
(10) Pub. No.: US 2015/0067113 A1
(43) Pub. Date: Mar. 5, 2015

(54) ADAPTIVE NETWORK CONTROL SYSTEM AND METHOD THEREOF

(71) Applicants: Kevin Dankwardt, Santa Clara, CA (US); Alon Konchitsky, Santa Clara, CA (US)

(72) Inventors: Kevin Dankwardt, Santa Clara, CA (US); Alon Konchitsky, Santa Clara, CA (US)

(21) Appl. No.: 14/011,569

(22) Filed: Aug. 27, 2013

(51) Int. Cl. H04L 12/24

(52) U.S. Cl. CPC H04L 41/0816
USPC 709/221

(57) ABSTRACT

A centralized configuration controlling system for configuring network devices is provided. The centralized configuration controlling system includes a retrieval component for retrieving configuration data, and operating parameters related to performance of a plurality of network devices in a network. The centralized configuration controlling system includes a processing component for processing retrieved operating parameters of the plurality of network devices based upon predefined rules to generate revised configuration data for the plurality of network devices. The centralized configuration controlling system includes a configuration component for configuring the plurality of network devices based upon the revised configuration data.

### BACKGROUND

1. Field of the Invention

Embodiments of the present invention relate to networks. More particularly, embodiments of the present invention provide a system and a method for configuring network devices in a network.

2. Description of Related Art

A network is a collection of network devices, interconnected for bi-directional exchanges of information. A local area network (i.e., “LAN”) is an interconnection of plural computer systems and network devices distributed around a single site. A wide area network (i.e., “WAN”) is an interconnection of plural computer systems located at different sites. Traditionally, computer systems have used modems to connect to a WAN via public switched telephone network (i.e., “PSTN”) or public switched data network (i.e., “PSDN”). Recently, WANs utilize integrated services digital networks (i.e., “ISDNs”), which enable data to be transmitted without modems, to interconnect computer systems have become more common. Finally, Internet is a collection of networks interconnected by a WAN.

Many network devices, for example, routers, gateways and hubs, store configuration data that defines how the network devices operate. For example, configuration data of a network device may define interfaces, communications protocols, security protocols and operational parameters for the network device. Configuring of network devices is conventionally done manually, for example by using a text editor to create a text file having a set of configuration data for the network device. The text file is downloaded to the network device and the network device starts using the configuration data.

Over time, circumstances may require that the configuration data of controlled devices such as routers and switches is required to be updated. For example, configuration data may need to be updated to reflect a change in definition of an existing interface, or to add a new interface definition. As another example, configuration data may need to be updated to change operational parameters of a network device. In this situation, all of the configuration data is retrieved from the network device and then manually edited. The updated configuration data is then downloaded to the network device and the network device begins using the updated configuration data.

Manually creating and editing network device configuration data is tedious and prone to errors, particularly for network devices that use large amounts of configuration data. The file containing all of the configuration data for the network device must be downloaded and then manually edited. Further, conventional solutions provide only a localized control of configuration of the network devices as they receive operating data from the network devices located within a particular location. Furthermore, conventional practices require retrieval of operating parameters from the network devices at periodic time interval, which is sometimes useless, and waste of resources on most of the occasions.

Based on the foregoing, there is a need for an approach for managing network device configuration data that does not suffer from limitations of prior approaches is highly desirable. There is a further need for an approach for managing network device configuration data that is more user friendly and efficient than conventional approaches. Thus, it can be readily seen from the foregoing that it would be desirable to simplify the task of configuring a local or remotely located network device.

### SUMMARY

Embodiments in accordance with the present invention provide a centralized configuration controlling system for configuring network devices. The centralized configuration controlling system includes a retrieval component for retrieving configuration data, and operating parameters related to performance of a plurality of network devices in a network. The centralized configuration controlling system further includes a processing component for processing retrieved operating parameters of the plurality of network devices based upon predefined rules to generate revised configuration data for the plurality of network devices. The centralized configuration controlling system further includes a configuration component for configuring the plurality of network devices based upon the revised configuration data.

Embodiments in accordance with the present invention further provide a centralized configuration controlling system for configuring network devices. The centralized configuration controlling system comprising one or more processors and a memory storing instructions which, when executed by the one or more processors, cause the one or more processors to perform following acts: retrieving configuration data, and operating parameters related to performance of a plurality of network devices, processing retrieved operating parameters of the plurality of network devices based upon predefined rules to generate revised configuration data for the plurality of network devices, and configuring the plurality of network devices based upon the revised configuration data.

Embodiments in accordance with the present invention further provide a system for configuring network devices. The system includes means for retrieving configuration data, and operating parameters related to performance of a plurality of network devices. The system further includes means for processing retrieved operating parameters of the plurality of network devices based upon predefined rules to generate revised configuration parameters. The system further includes means for configuring the plurality of network devices based upon the revised configuration data.

Further, the present invention can provide a number of advantages depending on its particular configuration. First, embodiments of the present invention provide a centralized controller for providing configuration and reconfiguration of the network devices from a central location. Since, the centralized controller is located in the central location; it receives network wide information and manages the traffic better. Moreover, embodiments of the present invention provide an adaptive rate of the updates, and adaptive retrieval of information from the network devices.

These and other advantages will be apparent from the disclosure of the present invention contained herein.

The preceding is a simplified summary of the present invention to provide an understanding of some aspects of the present invention. This summary is neither an extensive nor exhaustive overview of the present invention and its various embodiments. It is intended neither to identify key or critical elements of the present invention nor to delineate the scope of the present invention but to present selected concepts of the present invention in a simplified form as an introduction to the more detailed description presented below. As will be appreciated, other embodiments of the present invention are possible, utilizing, alone or in combination, one or more of the features set forth above or described in detail below.

### BRIEF DESCRIPTION OF THE DRAWINGS

The above and still further features and advantages of the present invention will become apparent upon consideration of the following detailed description of embodiments thereof, especially when taken in conjunction with the accompanying drawings, and wherein:

FIG. 1 illustrates an exemplary network environment where various embodiments of the present invention may be implemented;

FIG. 2 illustrates an exemplary embodiment in accordance with the present invention;

FIG. 3 illustrates another exemplary embodiment in accordance with the present invention;

FIG. 4 illustrates another exemplary embodiment in accordance with the present invention;

FIG. 5 illustrates another exemplary embodiment in accordance with the present invention; and

FIG. 6 is a flowchart of a method for configuring network devices, in accordance with an embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including but not limited to. To facilitate understanding, like reference numerals have been used, where possible, to designate like elements common to the figures.

### DETAILED DESCRIPTION

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read.

A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the present invention is considered to include a tangible storage medium or distribution medium and prior art-recognized equivalents and successor media, in which the software implementations of the present invention are stored.

The terms “determine”, “calculate” and “compute,” and variations thereof, as used herein, are used interchangeably and include any type of methodology, process, mathematical operation or technique.

The term “component” or “module” as used herein refers to any known or later developed hardware, software, firmware, artificial intelligence, fuzzy logic, or combination of hardware and software that is capable of performing the functionality associated with that element. Also, while the present invention is described in terms of exemplary embodiments, it should be appreciated those individual aspects of the present invention can be separately claimed.

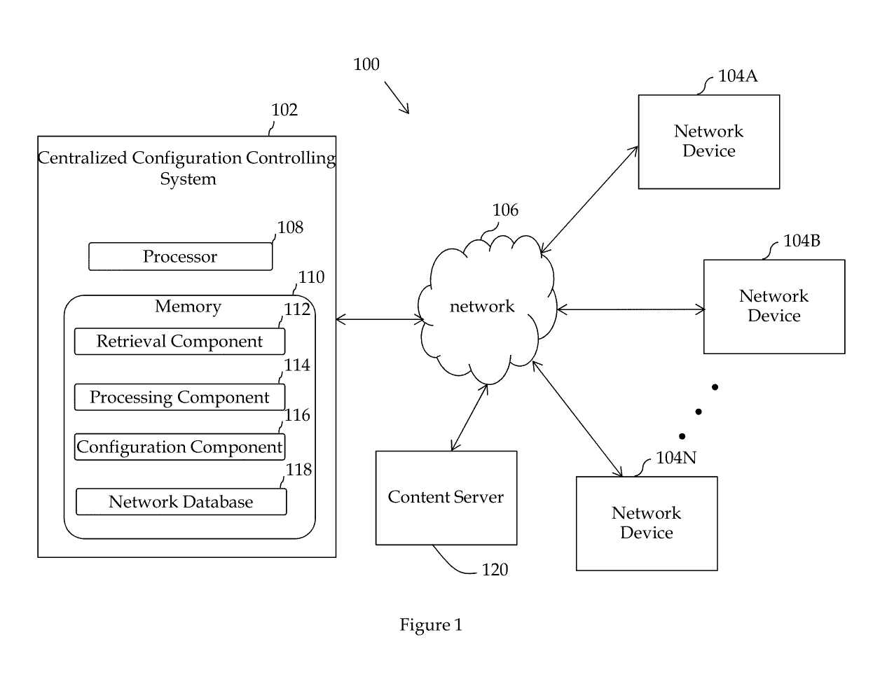

FIG. 1 illustrates an exemplary network environment 100 where various embodiments of the present invention may be implemented. The network environment 100 includes a centralized configuration controlling system 102 connected to a multiple of network devices 104a, 104b . . . 104n via a network 106. The network devices 104a, 104b . . . 104n (hereinafter may collectively be referred to as “network devices 104”) may refer to network devices that may be utilized for multiple network related functions, operations management, and traffic management by an administrator of the network. Examples of the network devices 104 may include a gateway, a router, a switch, a bridge, a hub, a repeater, and the like. The network 106 may include, but is not restricted to, a communication network such as Internet, PSTN, Local Area Network (LAN), Wide Area Network (WAN), Metropolitan Area Network (MAN), and so forth. In an embodiment, the network 106 can be a data network such as the Internet. Further, the messages exchanged between the centralized configuration controlling system 102 and the network devices 104, can comprise any suitable message format and protocol capable of communicating the information necessary for the centralized configuration controlling system 102 to receive performance related information from the network devices 104, and to send revised configuration information to the network devices 104 to configure the network devices 104.

FIG. 1 further illustrates exemplary block diagram of a system, such as the centralized configuration controlling system 102, in accordance with an embodiment of the present invention. In one embodiment, the centralized configuration controlling system 102 may be a computing device. In an embodiment, the centralized configuration controlling system 102 may be utilized for receiving performance metric (discussed later) from the network devices 104, process the performance metric, and to configure the network devices 104 based on revised configuration parameters. The centralized configuration controlling system 102 includes a processor 108 and a memory 110. In one embodiment, the processor 108 includes a single processor and resides at the centralized configuration controlling system 102. In another embodiment, the processor 108 may include multiple sub-processors and may reside at the centralized configuration controlling system 102, and other various locations in the network 106.

Further, the memory 110 includes one or more instructions that may be executed by the processor 108 to receive performance metric, process the configuration parameters, and generate revised configuration parameters. In one embodiment, the memory 110 includes a retrieval component 112, a processing component 114, a configuration component 116, network database 118, and other data (not shown in figure). The network database 118 may include details of network devices and predefined rules, and other data. The other data may include various data generated during processing of the performance parameters to generate revised configuration parameters. In one embodiment, the network database 118 is stored internal to the centralized configuration controlling system 102. In another embodiment, the network database 118 may be stored external to the centralized configuration controlling system 102, and may be accessed via the network 106.

Furthermore, the memory 110 of the centralized configuration controlling system 102 is coupled to the processor 108. The processor 108 of the centralized configuration controlling system 102 may also search for certain network devices that meet a specific criteria or property that is available through the network devices information stored in the network database 118. Further, in an embodiment of the present invention, the network devices 104 are configurable by the centralized configuration controlling system 102.

According to an embodiment of the present invention, the network environment 100 further includes a content server 120. The content server 120 may include information or content that may be desired by one or more network devices 104 inside the network 106, or one or more network devices (not shown in the Figure) outside the network 106. Further, the content server 120 may also include predefined rules about when and which network device may access content stored in the content server 120. Further, in an embodiment, the content server 120 may be internal to the centralized configuration controlling system 102. In another embodiment, the content server 120 may be outside of the centralized configuration controlling system 102.

The centralized configuration controlling system 102 may further have access to the network database 118 and/or the content server 120, having stored therein configuration details of all the network devices. In addition, the centralized configuration controlling system 102 may be configured to update the configuration details of the network devices 104.

The centralized configuration controlling system 102 is configured to direct network devices 104 as to their port configuration. Each of the network devices 104 includes its own configuration data. The configuration data for a network device may vary across network devices depending upon a variety of factors, such as the functionality of the network devices and how the network devices are configured.

The configuration data for a network device 104 may be required to be changed some time. For example, suppose that a determination is made that a network device 104 is to support a new interface. The centralized configuration controlling system 102 will generate configuration data for the new interface and will download the new configuration data to the network device. As another example, a new operational parameter may be required to be added to the definition of all interfaces of the network devices 104. In this situation, the centralized configuration controlling system 102 may add the new operational parameter to the common interface of the network devices 104. Further, the centralized configuration controlling system 102 may delete some functional groups of the network devices 104 if the corresponding configuration data is no longer used.

As discussed above, the centralized configuration controlling system 102 includes the retrieval component 112, the processing component 114, and the configuration component 116. The retrieval component 112, the processing component 114, and the configuration component 116 may be any known or later developed hardware, software, firmware, artificial intelligence, fuzzy logic, or combination of hardware and software that is capable of performing the functionality associated with that component.

The retrieval component 112 is configured to retrieve configuration data from each of the network devices. The retrieval component 112 is further configured to retrieve performance of each of the network devices (i.e., performance metrics). The performance metric may include operating parameters related to performance of the plurality of devices including internal system network buffer sizes, receive/transmit socket memory buffer sizes, number of memory buffers, TCP window sizes, time stamping, selective acknowledgment, saving of connection metrics, backlog queue sizes. The centralized configuration controlling system 102 is configured to retrieve configuration data and performance metric data continuously at different time intervals. According to an embodiment of the present invention, rate of the updates, and the nature of the information is adaptive. The rate of the updates and nature of the information may be learned intelligently based on artificial intelligence rules stored in the network database 118.

The processing component 114 is configured to process the performance metric. The processing component 114 may further process the configuration data and performance metrics data of the network devices to prepare revise configuration data for each or some of the network devices 104 based on their performance data and predefined rules.

The configuration component 116 is further configured to apply the revised configuration data to the network devices 104. The configuration component 116 may upload the revised configuration data at the network devices 104 to improve the performance of the network devices 104 in the network 106. In an embodiment of the present invention, the configuration component 116 may ask an administrator to approve the revised configuration data. In another embodiment of the present invention, the configuration component 116 does not require approval of the revised configuration data from the administrator, and automatically applies the revised configuration data to the network devices 104.

In an embodiment, the configuration component 116 of the centralized configuration controlling system 102 is configured to provide routing of packets among the network device, i.e., selecting an optimum path for a packet to travel from a source/origin network device to a destination network device based upon traffic conditions of the entire network. The centralized configuration controlling system 102 is further configured to improve performance such as, but not limited to: latency, throughput, or security of the network devices. The centralized configuration controlling system 102 is further configured to provide configuration of operating system variables including internal system network buffer sizes, receive/transmit socket memory buffer sizes, number of memory buffers, TCP window sizes, time stamping, selective acknowledgment, saving of connection metrics, backlog queue sizes, etc. The available configurable options at a particular network device 104 are dependent upon the features of the network device 104.

According to an embodiment of the present invention, the centralized configuration controlling system 102 is configured to adapt the network devices and the network to current and anticipated demand based on a purview of a number of network devices, current configuration information, historical configuration and performance data. The centralized configuration controlling system 102 is configured to receive network-wide information (rather than only local information for some network devices), and utilize the information to make informed decisions across network devices and inform the network devices 104 intelligently.

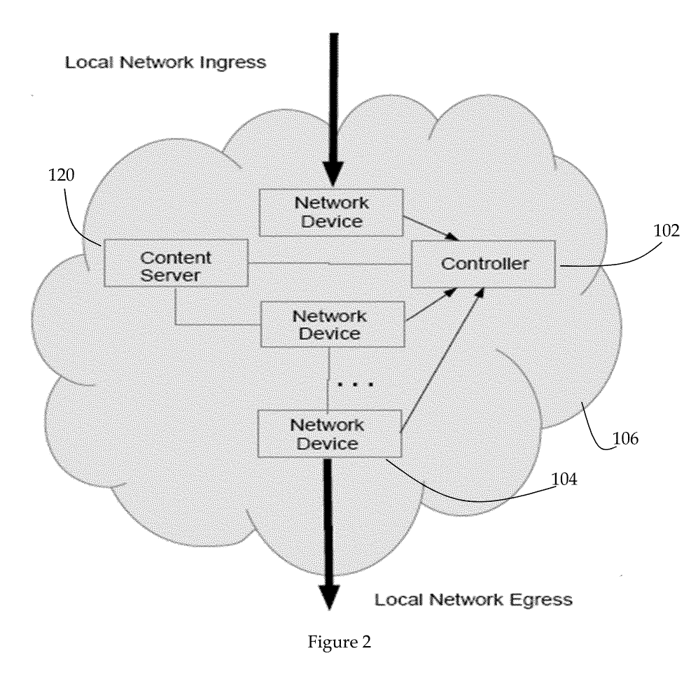

FIG. 2 illustrates an exemplary embodiment of the present invention. A request for content (e.g., a disk file) may come from one or more network devices outside the network 106, as shown in the Figure. The centralized configuration controlling system 102 (hereinafter simply called as ‘controller’) may receive the request, and analyze the request to know source of the request and desired content of the request. The controller 102 may further retrieve rules stored in the network database 118 or the content server 120, to check whether the network device (from where the request came) is authorized to make the request or receive the content of the request. If the network device is authorized, the controller 102 directs the content server 120 to send the desired content of the request to the network device.

Further, in an embodiment of the present invention, the network devices 104 send performance and configuration data to the controller 102, as shown in the FIG. 2. In an embodiment of the present invention, the network devices 104 may send the performance data and the configuration data to the controller 102 at different times. According to an embodiment of the present invention, rate of the updates, and the nature of the information sent from the network devices 104 to the controller 102 is adaptive. The rate of the updates and nature of the information may be learned intelligently based on artificial intelligence rules stored in the content server 120 or the network database 118. The controller 102 may utilize the received performance and configuration data for its use in calculating optimal configurations of the network devices 104.

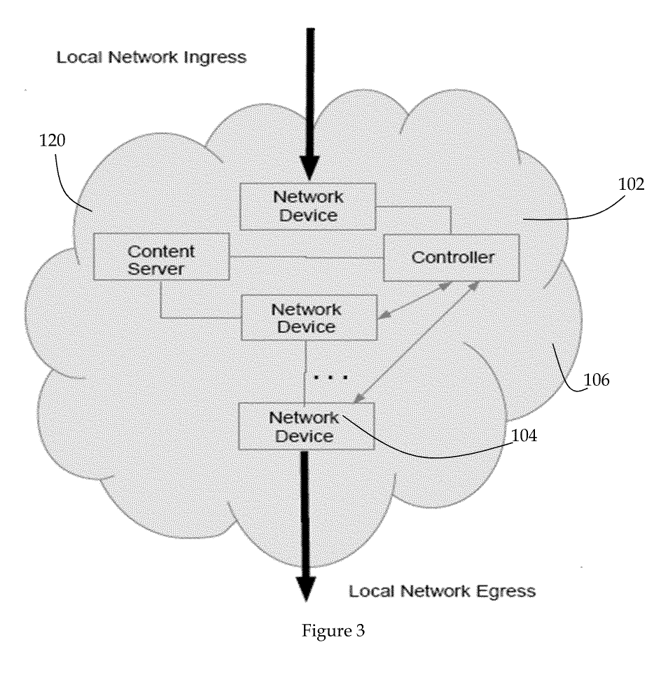

The controller 102 may further deliver the calculated optimal configurations to the network devices 104 and direct the network devices 104 as to optimize their operating system configuration, as shown in FIG. 3. The controller 102 is configured to provide configuration of operating system variables including internal system network buffer sizes, receive/transmit socket memory buffer sizes, number of memory buffers, TCP window sizes, time stamping, selective acknowledgment, saving of connection metrics, backlog queue sizes, etc. In an embodiment of the present invention, the controller 102 may ask an administrator to approve the revised configuration data. In another embodiment of the present invention, the controller 102 does not require approval of the revised configuration data from the administrator, and automatically applies the revised configuration data to the network devices 104.

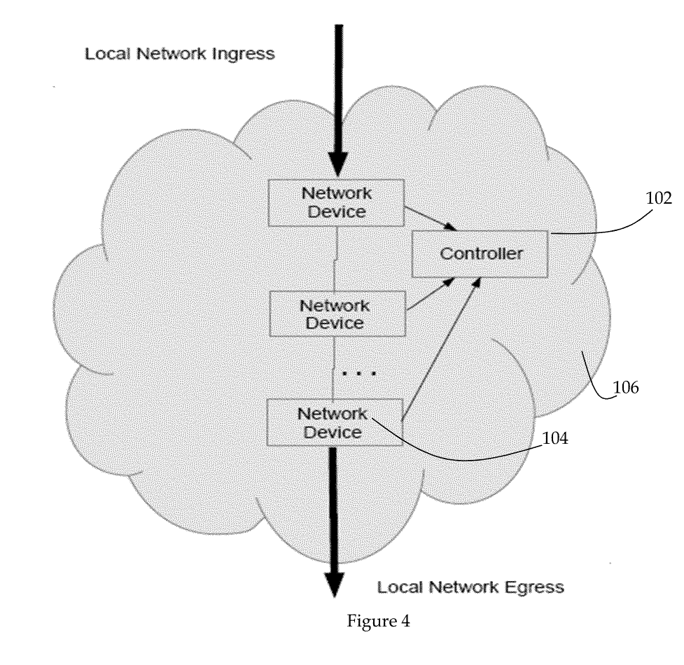

FIG. 4 illustrates another exemplary embodiment of the present invention. The network devices 104 send performance and configuration data to the controller 102. The controller 102 may receive the performance and configuration data and utilizes the performance and configuration data to calculate optimal configurations for each of the network device 104 in the network 106.

According to an embodiment of the present invention, the network 106 may be used for traffic that just transits this network domain. In an embodiment, the controller 102 may receive a request (coming from a network device that is located outside of the network 106) to cross the network 106, and to reach another network device, which is also outside of the network 106. The controller 102 may receive and analyze such requests. The controller 102 may further calculate a suitable path for the request (or traffic) to cross the network 106 to reach another network. In an embodiment of the present invention, the controller 102 may calculate optimal path for the request so that the request reaches the destination in a shortest possible time. For example, the controller 102 may calculate traffic at each of the network device 104 in the network 106 based on performance and configuration data sent by the each of the network devices 104. Based on the calculated traffic, the controller 102 may calculate the optimal path for the request, so that the request may cross the network 106 in the shortest possible time. In an embodiment, time is taken as parameter to deliver the request outside of the network 106. In another embodiment, some other parameter (e.g., preference, security etc.) may be considered to deliver the request outside of the network 106. The controller 102 is located in a central location and it receives network wide information and manages the traffic better.

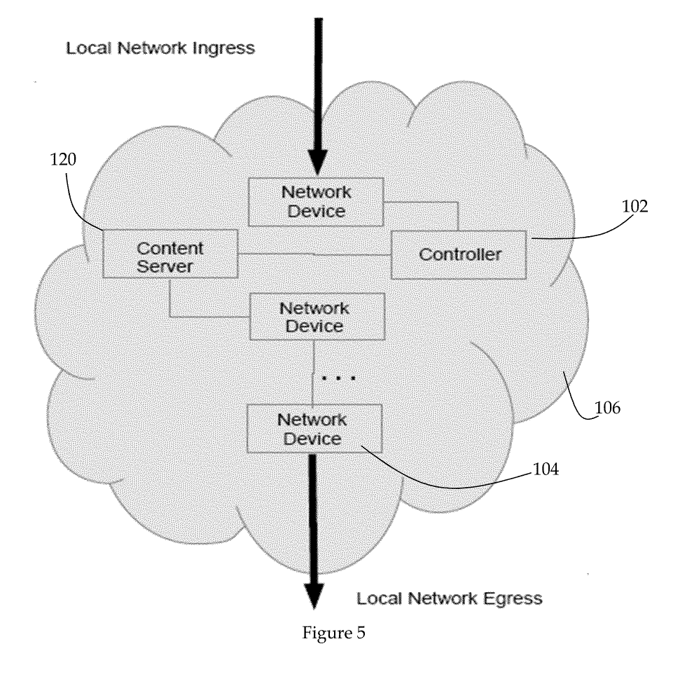

FIG. 5 illustrates another exemplary embodiment of the present invention. In this figure, a request for content (e.g., a disk file) comes from outside of the network 106. The controller 102 may receive the request, and analyze the request. The controller 102 may further direct the content server 120 as to which network device 104 to send the content.

Further, in an embodiment of the present invention, the controller 102 may direct the content server 120 as to optimize operating system configuration of the content server 120. For example, based on the request, the controller 102 may determine source and desired content of the request. Further, the controller 102 may also receive performance and configuration data of the network devices 104. Furthermore, in an embodiment of the present invention, the controller 102 may also receive performance and configuration data of the content server 120.

In an embodiment of the present invention, the content server 120 may send the performance data and the configuration data to the controller 102 at different times. According to an embodiment of the present invention, rate of the updates, and the nature of the information sent from the content server 120 to the controller 102 is adaptive. The rate of the updates and nature of the information may be learned intelligently based on artificial intelligence rules stored in the content server 120 or the network database 118.

The controller 102 may receive the performance and configuration data of the content server 120, and calculate revised configuration data for the content server 120 based on predefined rules and configuration/performance data of the network devices 104. The controller 102 may further deliver the revised configuration data to the content server 120 so as to optimize operating system configuration of the content server 120.

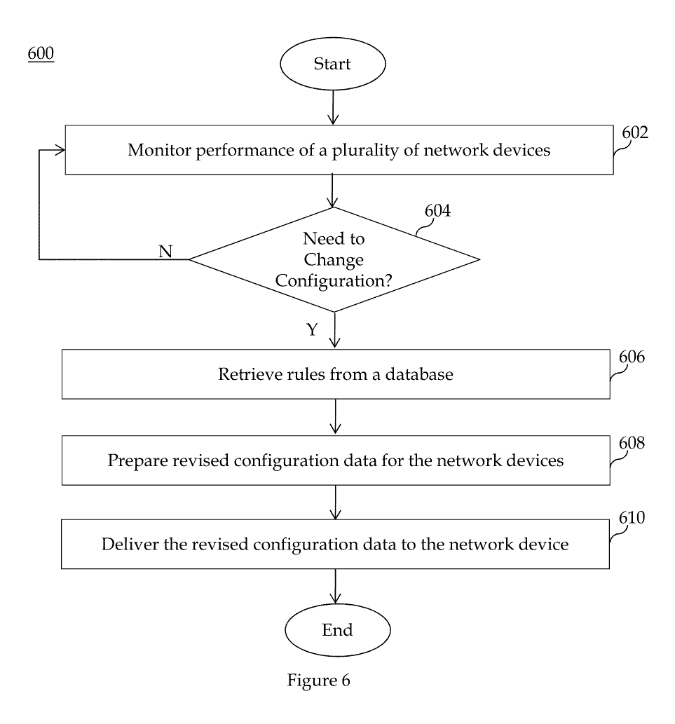

FIG. 6 is a flowchart of a method 600 for configuring the network devices. At step 602, performance of the plurality of network devices in a network is monitored. Examples of the network devices may include a gateway, a router, a switch, a bridge, a hub, a repeater, a content server and the like. In an embodiment of the present invention, a performance metric may be retrieved from the network devices. The performance metric may include operating parameters related to performance of the plurality of devices including internal system network buffer sizes, receive/transmit socket memory buffer sizes, number of memory buffers, TCP window sizes, time stamping, selective acknowledgment, saving of connection metrics, backlog queue sizes. The performance of individual network devices may be ascertained based on the performance metric. Further, configuration data of the network devices may be retrieved. According to an embodiment of the present invention, rate of the updates, and the nature of the information retrieved from the network devices is adaptive. The rate of the updates and nature of the information may be learned intelligently based on artificial intelligence rules stored in the network database 118. In an embodiment of the present invention, the monitoring may be performed by the retrieval component 112.

At step 604, it is determined whether there is a need to change configuration of the network devices. In an embodiment of the present invention, a change in the configuration of network devices may be required to improve the performance of network as a whole. For example, traffic in one part of the network may be higher than a threshold, and the traffic in another part of network may be less than average. A change in routing configuration of packets may help to balance out the traffic in the network. Further, in another embodiment of the present invention, a change in the configuration of network devices may be needed to achieve a desired function in the network. According to an embodiment of the present invention, retrieved operating parameters related to performance of the plurality of network devices may be compared with desired operating parameters. In an embodiment of the present invention, the determination may be performed by the processing component 114.

At step 606, predefined rules may be retrieved from the network database. In an embodiment of the present invention, the predefined rules may be artificial intelligence rules stored in the network database 118. In an embodiment of the present invention, the retrieving may be performed by the processing component 114.

At step 608, revised configuration data is prepared based on the retrieved rules, performance details, and retrieved configuration data of the network devices. In an embodiment of the present invention, the preparing may be performed by the processing component 114.

Thereafter, at step 610, revised configuration information is delivered to the network devices. In an embodiment, the revised configuration information is uploaded to the network devices. In an embodiment of the present invention, the revised configuration may cause routing of packets among the network device, i.e., selecting an optimum path for a packet to travel from an origin to a destination based upon traffic conditions of the entire network. In another embodiment of the present invention, the revised configuration data may cause provide configuration of operating system variables including internal system network buffer sizes, receive/transmit socket memory buffer sizes, number of memory buffers, TCP window sizes, time stamping, selective acknowledgment, saving of connection metrics, backlog queue sizes, etc.

According to an embodiment of the present invention, the revised configuration data may adapt the network devices and the network to current and anticipated demand based on a purview of a number of network devices, current configuration information, historical configuration and performance data. The configuring involves receiving network-wide information (rather than only local information for some network devices), and utilizing the information to make informed decisions across network devices and inform the network devices intelligently. In an embodiment of the present invention, the delivering may be performed by the configuration component 116.

The exemplary systems and methods of this present invention have been described in relation to an exemplary environment. However, to avoid unnecessarily obscuring the present invention, the preceding description omits a number of known structures and devices. This omission is not to be construed as a limitation of the scope of the claimed invention. Specific details are set forth to provide an understanding of the present invention. It should however be appreciated that the present invention may be practiced in a variety of ways beyond the specific detail set forth herein.

Furthermore, while the exemplary embodiments of the present invention illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices, such as a switch, server, and/or adjunct, or collocated on a particular node of a distributed network, such as an analog and/or digital telecommunications network, a packet-switch network, or a circuit-switched network.

It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the present invention.

A number of variations and modifications of the present invention can be used. It would be possible to provide for some features of the present invention without providing others.

For example, in one alternative embodiment, the systems and methods of this present invention can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like.

In general, any device(s) or means capable of implementing the methodology illustrated herein can be used to implement the various aspects of this present invention. Exemplary hardware that can be used for the present invention includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment of the present invention, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this present invention is dependent on the speed and/or efficiency requirements of the system, the particular function, and the particular software or hardware systems or microprocessor or microcomputer systems being utilized.

In yet another embodiment of the present invention, the disclosed methods may be partially implemented in software that can be stored on a storage medium, executed on programmed general-purpose computer with the cooperation of a controller and memory, a special purpose computer, a microprocessor, or the like. In these instances, the systems and methods of this present invention can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present invention describes components and functions implemented in the embodiments with reference to particular standards and protocols, the present invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, sub-combinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and/or reducing cost of implementation.

The foregoing discussion of the present invention has been presented for purposes of illustration and description. The foregoing is not intended to limit the present invention to the form or forms disclosed herein. In the foregoing Detailed Description for example, various features of the present invention are grouped together in one or more embodiments, configurations, or aspects for the purpose of streamlining the disclosure. The features of the embodiments, configurations, or aspects of the present invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the present invention.

Moreover, though the description of the present invention has included description of one or more embodiments, configurations, or aspects and certain variations and modifications, other variations, combinations, and modifications are within the scope of the present invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A centralized configuration controlling system for configuring network devices, comprising:
a retrieval component for retrieving configuration data, and operating parameters related to performance of a plurality of network devices in a network;
a processing component for processing retrieved operating parameters of the plurality of network devices based upon predefined rules to generate revised configuration data for the plurality of network devices; and
a configuration component for configuring the plurality of network devices based upon the revised configuration data.

2. The centralized configuration controlling system of claim 1, wherein the retrieval component retrieves network wide information through the plurality of network devices.

3. The centralized configuration controlling system of claim 1, wherein the retrieval component retrieves the operating parameters of the plurality of network devices at adaptive time intervals.

4. The centralized configuration controlling system of claim 3, wherein the retrieval component is configured to compute adaptive time intervals based upon artificial intelligence rules stored in a network database.

5. The centralized configuration controlling system of claim 1, wherein the centralized configuration controlling system providing a centralized control of the configuration data of the plurality of network devices.

6. The centralized configuration controlling system of claim 1, wherein the plurality of network devices comprising a gateway, a router, a switch, a bridge, a hub, and a repeater.

7. The centralized configuration controlling system of claim 6, wherein the plurality of network devices storing their own configuration data in a local database.

8. The centralized configuration controlling system of claim 7, wherein the configuration component uploads the revised configuration data at the plurality of network devices.

9. The centralized configuration controlling system of claim 1, wherein the configuration component provides an optimum path for packets going from a source network device to destination network device based upon traffic conditions in entire network.

10. The centralized configuration controlling system of claim 1, wherein the configuration component configures operating system variables of the plurality of network devices.

11. The centralized configuration controlling system of claim 10, wherein the operating system variables include internal system network buffer sizes, receive/transmit socket memory buffer sizes, number of memory buffers, TCP window sizes, time stamping, selective acknowledgment, saving of connection metrics, and backlog queue sizes.

12. The centralized configuration controlling system of claim 11, wherein the configuration component adapts the plurality of network devices for a traffic load based upon purview of the plurality of network devices, current configuration information, historical configuration and performance data.

13. A centralized configuration controlling system for configuring network devices, comprising one or more processors and a memory storing instructions which, when executed by the one or more processors, cause the one or more processors to perform following acts:
retrieving configuration data, and operating parameters related to performance of a plurality of network devices;
processing retrieved operating parameters of the plurality of network devices based upon predefined rules to generate revised configuration data for the plurality of network devices; and
configuring the plurality of network devices based upon the revised configuration data.

14. The centralized configuration controlling system of claim 13, wherein the retrieving comprises retrieving the operating parameters of the plurality of network devices at adaptive time intervals.

15. The centralized configuration controlling system of claim 13, wherein the configuring comprises providing a centralized control of the configuration data of the plurality of network devices.

16. The centralized configuration controlling system of claim 13, wherein the plurality of network devices comprising a gateway, a router, a switch, a bridge, a hub, and a repeater.

17. The centralized configuration controlling system of claim 13, wherein the configuring comprises uploading the revised configuration data at the plurality of network devices.

18. The centralized configuration controlling system of claim 13, wherein the configuring comprises providing an optimum path for a packet from a source network device to destination network device based upon traffic conditions in the entire network.

19. The centralized configuration controlling system of claim 13, wherein the configuring comprises configuring operating system variables of the plurality of network devices.

20. A system for configuring network devices, the system comprising:
means for retrieving configuration data, and operating parameters related to performance of a plurality of network devices;
means for processing retrieved operating parameters of the plurality of network devices based upon predefined rules to generate revised configuration parameters; and
means for configuring the plurality of network devices based upon the revised configuration data.
